(19) United States
(12) Patent Application Publication
(10) Pub. No.: US 2007/0082409 A1
(43) Pub. Date: Apr. 12, 2007

(54) Method and apparatus for measuring cartilage condition biomarkers

(75) Inventors: Michael D. Morris, Ann Arbor, MI (US); Blake J. Roessler, Ann Arbor, MI (US); Gurjit S. Mandair, Ann Arbor, MI (US); Karen A. Dehring, Ypsilanti, MI (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: THE REGENTS OF THE UNIVERSITY OF MICHIGAN, Ann Arbor, MI (US)

(21) Appl. No.: 11/521,295

(22) Filed: Sep. 14, 2006

Related U.S. Application Data
(60) Provisional application No. 60/717,512, filed on Sep. 15, 2005.

(51) Int. Cl. G01N 21/62

(52) U.S. Cl. 436/171

(57) ABSTRACT

In a method for measuring cartilage condition biological markers, a surface-enhanced Raman spectroscopy (SERS) substrate is irradiated using a light source, the SERS substrate having deposited thereon a biological sample. Light scattered by the SERS substrate is received, and spectral content information associated with the received light is determined. A level of a cartilage condition biological marker in the biological sample is determined based on the spectral content information.

### CROSS-REFERENCE TO RELATED APPLICATIONS

The present application claims the benefit of U.S. Provisional Application No. 60/717,512, filed Sep. 15, 2005, entitled “METHOD AND SYSTEM FOR MEASURING CARTILAGE CONDITION BIOMARKERS.” This provisional application is hereby incorporated by reference herein in its entirety.

### STATEMENT REGARDING FEDERALLY SPONSORED RESEARCH OR DEVELOPMENT

This invention was made with United States Government support under Grant numbers P30 AR46024, T32 AR07080, and T90 DK070071-01 awarded by the National Institutes of Health (Department of Health and Human Services). The United States Government may own certain rights in this invention.

### DESCRIPTION OF THE RELATED ART

Glycosaminoglycans (GAG's) are polysaccharides present in synovial fluid surrounding knee joints and may be either sulfated or unsulfated. The swelling capability of the GAG's provides protection from mechanical damage due to compression and aids in the lubrication of the joint space. It is believed that GAG's are secreted into serum as a response to cartilage damage.

Osteoarthritis is an important health care problem. It has been estimated that 40 million Americans and 70 to 90 percent of persons older than 75 years are affected by osteoarthritis. The prevalence of osteoarthritis among men and women is equal, though its symptoms occur earlier in women. Risk factors include age, joint injury, obesity, and mechanical stress.

Studies suggest physio-chemical alteration of the articular cartilage surface is an early event in the pathogenesis of osteoarthritis. The changes involve physical damage to structural matrix proteins, mediated by physical forces and degradative enzymes.

Current techniques for diagnosing or ruling out osteoarthritis include taking an X-ray image of a joint, analyzing blood samples, and analyzing synovial fluid withdrawn from the joint with a needle. The diagnosis is largely clinical because radiographic findings do not always correlate with symptoms. An X-ray image of a joint may indicate osteoarthritis if a normal space between the bones in a joint is narrowed, an abnormal increase in bone density is evident, or if bony projections or erosions are evident. A blood sample may indicate osteoarthritis or other cartilage disorders if elevated hyaluronic acid or byproducts of hyaluronic acid are present. Hyaluronic acid (HA) is a joint lubricant and elevated levels or the presence of its byproducts in the blood may indicate the lubricant's breakdown, a sign of osteoarthritis or other cartilage disorders. Inflammation of the synovial membrane leads to the enhanced secretion of pathological synovial fluids. Such fluids tend to contain a lower concentration of unsulfated GAG HA, as well as lower molecular weight unsulfated GAG HA, as compared to normal synovial fluids. These changes are undesirable as the GAG HA is responsible for the viscoelastic properties of synovial fluid, which aid in the lubrication and protection of articular cartilage from mechanical injury. The decline in HA concentration is caused by infiltration of the plasma fluid and proteins into the synovial fluid, whereas the molecular weight reduction is caused by abnormal metabolic processes occurring within the inflamed synovial structures.

Also, elevated levels of a factor called C-reactive protein, which is produced by the liver in response to inflammation, may indicate osteoarthritis. On the other hand, elevated levels of rheumatoid factor and so-called erythrocyte sedimentation rates may indicate rheumatoid arthritis rather than osteoarthritis. An analysis of synovial fluid withdrawn from the joint may indicate osteoarthritis if cartilage cells are present in the fluid. On the other hand, a high white blood cell count in the synovial fluid is an indication of infection, and high uric acid in the synovial fluid is an indication of gout.

### SUMMARY OF THE DISCLOSURE

Methods and apparatus are provided for measuring a biomarker indicative of a cartilage condition. Generally speaking, a surface-enhanced Raman spectroscopy (SERS) substrate, on which a biological sample is deposited, may be irradiated using a light source. Light scattered by the SERS substrate may be analyzed to determine a level of one or more biomarkers indicative of a cartilage condition.

In one embodiment, a method for measuring cartilage condition biological markers may include irradiating a SERS substrate using a light source, the SERS substrate having deposited thereon a biological sample, and receiving light scattered by the SERS substrate. The method also may include determining spectral content information associated with the received light, and determining a level of a cartilage condition biological marker in the biological sample based on the spectral content information.

In another aspect, an apparatus for measuring cartilage condition biological markers may include an illumination system to illuminate a surface-enhanced Raman spectroscopy (SERS) substrate, the SERS substrate having deposited thereon a biological sample, and a light receiver to receive light from scattered by the SERS substrate. The apparatus may also include a spectrum analyzer optically coupled to the light receiver, the spectrum analyzer configured to generate spectral content information associated with the received light, and a computing device communicatively coupled to the spectrum analyzer, the computing device configured to determine a level of a cartilage condition biological marker in the biological sample based on the spectral content information.

### BRIEF DESCRIPTION OF THE DRAWINGS

The features and advantages of the apparatus and methods described herein will be best appreciated upon reference to the following detailed description and the accompanying drawings, in which:

FIG. 1 is a flow diagram of one embodiment of a method for measuring a cartilage condition biomarker;

FIG. 2 is a block diagram of one embodiment of an apparatus for measuring a cartilage condition biomarker;

FIG. 3 is a block diagram of a computer that can be used with the apparatus of FIG. 2;

FIG. 4A is an image of a droplet on a surface-enhanced Raman spectroscopy (SERS) substrate;

FIG. 4B is a chart including measured spectral content information corresponding to the droplet of FIG. 4A;

FIG. 5A is another image of a droplet on a SERS substrate;

FIG. 5B is a chart including measured spectral content information corresponding to the droplet of FIG. 5A;

FIG. 6A is another image of a droplet on a SERS substrate;

FIG. 6B is a chart including measured spectral content information corresponding to the droplet of FIG. 6A;

FIG. 7A is yet another image of a droplet on a SERS substrate; and

FIG. 7B is a chart including measured spectral content information corresponding to the droplet of FIG. 7A.

### DETAILED DESCRIPTION

Glycosaminoglycan (GAG) molecules in serum and/or synovial fluid may serve as an indicator of cartilage conditions such as osteoarthritis (OA). Surface-enhanced Raman spectroscopy (SERS) is one technique that may be used to detect biological indicators of cartilage conditions. With SERS, a sample to be analyzed is placed on a SERS substrate. A SERS substrate may be a substrate having an array of metallic (e.g., gold, silver, coppers, etc.) or metal coated structures that when illuminated give rise to locally intense electromagnetic fields and thereby lead to surface-enhanced Raman spectra. A SERS substrate may include structures spaced approximately 50 to 500 nanometers apart. The substrate may comprise silicon, polymer, or any other suitable substrate. In one particular example, the SERS substrate comprises a silicon substrate with regular arrays of very small posts, needles, etc., covered with a thin layer of gold. Thus, this example of a SERS substrate is, in effect, an array of gold posts on a planar gold surface. Also, a SERS substrate may comprise silicon photonic crystals that are etched with void architectures and coated with a layer of gold, making a SERS-active surface.

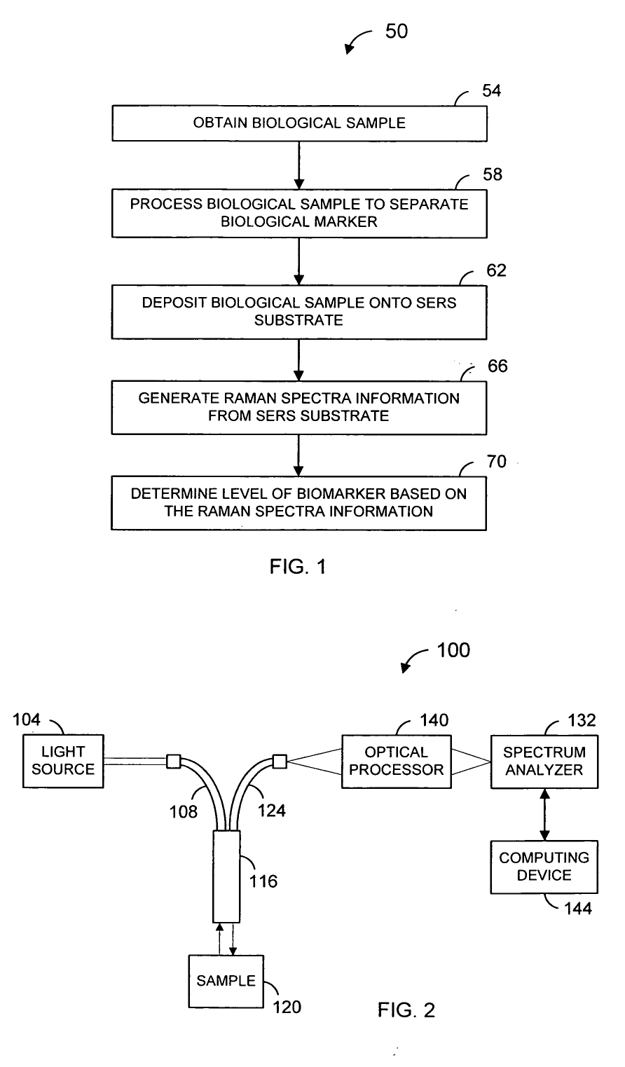

FIG. 1 is a flow diagram of an example method 50 for measuring levels of biomarkers indicating a cartilage condition such as OA. At a block 54, a biological sample may be obtained. For example, synovial fluid or serum may be obtained from a patient. At a block 58, the biological sample may be processed to remove at least some proteins that have Raman bands overlapping with Raman bands of cartilage condition biological marker. For example, centrifugal chromatography may be used. A variety of techniques may be used, such as one or more of filtration, protein precipitation, ultracentrifugation, etc. The particular technique that is used may depend on the biomarker that is to be measured. Initial experiments suggest that filtration may not reduce from synovial fluid proteins that interfere with HA. This may be because HA nonspecifically binds with synovial fluid proteins such as albumin or globulin. These initial experiments suggest that protein precipitation followed with ultracentrifugation may adequately reduce from synovial fluid proteins that interfere with HA. For example, trichloric acid (TCA) may be used for protein precipitation. Although residual TCA solvent may remain, the main bands of TCA are in the 600-800 cm⁻¹ region and do not significantly interfere with at least some of the HA signal. Block 58 is optional and may be omitted if desired.

At a block 62, a portion of the biological sample is deposited on a SERS substrate. This may comprise, for example, depositing a small portion of liquid onto the SERS substrate and allowing the droplet to dry naturally under ambient conditions. Other techniques may be used as well. If HA concentrations in synovial fluid are to be analyzed, a small volume of the synovial fluid may be deposited onto the SERS substrate and allowed to dry naturally under ambient conditions. Typically, HA is precipitated in a ring, with residual small molecules located in the center. Generally, the formation of a dried ring onto a solid surface is dictated by capillary flow, and can be affected by variables such as substrate material, analyte concentration, speed of evaporation, etc.

Because most ring formation studies are performed on flat substrates, such as silicon, mica or Teflon©, light microscopy is frequently used to follow solvent evaporation and examine the morphology of the resulting ring formation. The dimensions of the substrates are typically compatible with other microscope-based analytical tools such as cross-polarized light microscopy, fluorescence or microspectroscopy. Because the ring formation can function simultaneously as both a low resolution separation and a preconcentration method, it can help overcome the well-known limitations of fluorescence interference and high sample concentration requirements that are inherent in normal Raman spectroscopy. However, normal Raman spectroscopic detection of rings may not always be feasible for weakly scattering biomolecules, such as HA. SERS of HA droplets dried on gold-coated SERS substrates can be used in conjunction with the ring formation technique to overcome this problem. Both the preconcentration effect of the dried ring and the surface-enhancement seems to offer an additional improvement in the Raman signal intensity of weakly scattering biomolecules such as HA.

Initial experiments seem to indicate that droplets having HA tend to dry with an asymmetric ring shape on a SERS substrate. The droplet shape was often seen to be similar to an octagon-type shape. Similar droplet shapes were observed when aqueous HA solutions at various concentrations (e.g., 0.25-6 mg/ml) were deposited onto a SERS substrate. In addition to the non-spherical shape of the droplet, asymmetric concentric rings at droplet edges were observed when highly concentrated aqueous HA solutions were deposited on a SERS substrate. Previous studies have indicated that concentric ring formation may be concentration dependent. Moreover, formation of concentric rings may be related to entanglement of polymer chains because the concentric rings are not prominent at concentrations below 2 mg/ml. At concentrations greater than 2 mg/ml, it is possible that chain entanglement increases and affects both the hygroscopic nature and mobility of the polysaccharide. Aggregation of HA is more likely at these higher concentrations. This “clumping” of HA may affect the droplet formation. The presence of these concentric rings does not prevent the collection of HA Raman spectra, and may provide additional information about the size distribution of the polysaccharide. Deposition of polygonal-type rather than circular rings may be a result of the interplay between evaporation and the geometry of the SERS substrate.

Then, at a block 66, Raman spectra information for the SERS substrate is generated. For example, the SERS substrate may be irradiated using a light source, and Raman spectra information may be generated based on light scattered by the SERS substrate. If a deposition technique is employed that results in the formation of rings, optical and/or optomechanical techniques may be utilized to generate circular, octagonal-type, polygonal-type, etc., laser illumination patterns. Of course, a linear-type illumination pattern may be utilized as well.

At a block 70, a level of the cartilage condition biological marker in the biological sample may be determined based on the spectra information. The biological marker may be one or more glycosaminoglycans, for example. For instance, the biological marker may comprise HA, which may be indicative of osteoarthritis if present at elevated levels in blood serum. For example, serum fluid HA levels of approximately 30.2+/−19.6 nanograms/milliliter have been correlated with future (approximately two years) joint space narrowing related to osteoarthritis patients. Also, decreased levels of HA in synovial fluid may be indicative of osteoarthritis. For example, synovial fluid HA levels of approximately 0.10 to 1.14 milligrams/milliliter have been observed in osteoarthritis patients. Determining the level may comprise determining one or more band heights, one or more band areas, one or more band widths, etc. Based on initial experiments, Raman bandwidth may be a more robust indicator of HA concentration because it may be more independent of small variations in the substrate surface and can be used at analyte concentrations that yield monolayer or multilayer deposits. In experiments with pooled human serum, a candidate biomarker Raman band for hyaluronic acid was observed at approximately 1043 cm⁻¹. This band appeared to have the least interference (as compared to bands at approximately 1126 cm⁻¹, 947 cm⁻¹, and 895 cm⁻¹, e.g.) from bands corresponding to serum proteins. If the block 58 is utilized, other bands may be utilized as well. For instance, any one or more of the bands corresponding to HA (for example, the bands approximately at 1126 cm⁻¹, 1043 cm⁻¹, 947 cm⁻¹, and 895 cm⁻¹) could be analyzed. Further, other bands may be utilized in conjunction with separation techniques that isolate hyaluronic acid from serum proteins with bands at similar positions in the Raman spectrum.

Table 1 includes Raman bands of HA based on literature reports of the spectra of aqueous and solid HA. One or more of these bands could be analyzed.

TABLE 1

| Raman Shift (cm⁻¹) | Band Assignment |
|---|---|
| 899 | β-linkages |
| 945 | C—C stretch |
| ˜1050 | C—O, C—C |
| ˜1100 | C—O—H bend, acetyl group |
| ˜1130 | C—C |
| ˜1150 | C—O, C—C, Oxygen bridge |
| ˜1210 | CH₂ twist |
| 1330 | CH bend, Amide III |
| ˜1410 | CH bend, amide II |
| ˜1460 | CH₂ bend |

In experiments with synovial fluid and including TCA protein precipitation followed by ultracentrifugation, candidate biomarker Raman bands for HA were observed at approximately 895 cm⁻¹, 945 cm⁻¹, 1042 cm⁻¹, and 1117 cm⁻¹. Although microscope images and Raman spectroscopy showed crystalline TCA in the center of the dried droplet deposit, Raman spectra show that some TCA was still contained in the outer HA-rich rings. A broad TCA band was observed between 830-860 cm⁻¹ and other bands were found at ˜945 cm⁻¹ and 1365 cm⁻¹. With the exception of the 945 cm⁻¹ band, TCA bands did not appear to overlap with HA Raman bands and were not sources of interference. One or more bands, such as the bands at approximately 895 cm⁻¹, 945 cm⁻¹, 1042 cm⁻¹, and 1117 cm⁻¹, could be analyzed.

The level determined at the block 70 may be used, at least in part, in determining whether a patient has a cartilage condition, in monitoring a cartilage condition, etc. The cartilage condition may be, for example, osteoarthritis, rheumatoid arthritis, chondromalacia, polychondritis, relapsing polychondritis, a genetic disorder, an acquired disorder, etc. Also, the cartilage tissue condition may be an increased risk of developing a disease such as osteoarthritis, rheumatoid arthritis, chondromalacia, polychondritis, etc. In some embodiments, an indicator associated with the cartilage tissue condition may be generated based on the level determined at the block 70 (or the level itself may be the indicator). Such an indicator may be used by a physician to help determine whether the patient has a cartilage condition, to monitor the progression of a cartilage condition, to monitor a response to treatment of a cartilage condition, etc. Such an indicator may be based on additional factors as well. For example, the indicator may be further based on one or more of an age of the patient, a weight of the patient, a history of weight of the patient, a blood test, a separate analysis of serum and/or synovial fluid, a medical history of the patient (e.g., past joint injuries), an X-ray, a family history of the patient, etc. The blocks in FIG. 1 may be repeated over time and this level information over the period of time may be used to generate the indicator.

The block 70 may include various processing techniques such as one or more of smoothing, curve fitting, subtraction of detector offset, correction for contributions from the substrate, baseline subtraction, any of a variety of multivariate techniques (e.g., band entropy target minimization (BTEM)), etc.

FIG. 2 is a block diagram of an example apparatus 100 that may be used to help measure cartilage condition biomarkers. The apparatus 100, which may be used for a Raman spectrometry analysis or an infrared (IR) analysis, for example, includes a light source 104 optically coupled to at least one optical fiber 108. For Raman spectrometry, the light source 104 may comprise a laser, for example, that generates substantially monochromatic light. The optical fiber 108 is optically coupled to an optical probe 116. The optical probe 116 may be positioned proximate to a SERS substrate 120, and may be used to irradiate the sample 120 with the light generated by the light source 104. The SERS substrate 120 may have deposited thereon a portion of a biological sample (e.g., synovial fluid, serum, etc.).

In one embodiment, the optical probe 116 is also optically coupled to one or more optical fibers 124 (depicted in FIG. 1 as only one optical fiber 124). In this embodiment, the optical probe 116 may be used to collect light scattered or reflected by the sample 120 and to transmit the scattered light through the optical fibers 124. This embodiment may be used for Raman spectrometry or for “attenuated total reflection” IR spectrometry.

The one or more optical fibers 124 are optically coupled to a spectrum analyzer 132 via an optical processor 140 which may include one or more lenses and/or one or more filters. The spectrum analyzer 132 may include, for example, a spectrograph optically coupled to an array of optical detectors, and is communicatively coupled to a computing device 144.

Many types of light sources 104 may be employed. With regard to Raman spectrometry, a substantially monochromatic light source can be used. In general, near-infrared wavelengths provide better depth of penetration into tissue. On the other hand, as wavelengths increase, they begin to fall outside the response range of silicon photo detectors (which have much better signal-to-noise ratios than other currently available detectors). One example of a light source that can be used is the widely available 830 nanometer diode laser. As another example, a 785 nanometer diode laser could be used.

Many other wavelengths may be used as well. In general, a wavelength of a light source may be chosen based on various factors including one or more of a desired depth of penetration, availability of photo detectors capable of detecting light at and near the wavelength, efficiency of photo detectors, cost, manufacturability, lifetime, stability, scattering efficiency, penetration depth, etc. Any of a variety of substantially monochromatic light sources can be used, including commercially available light sources. For example, the article “Near-infrared multichannel Raman spectroscopy toward real-time in vivo cancer diagnosis,” by S. Kaminaka, et al. (Journal of Raman Spectroscopy, vol. 33, pp. 498-502, 2002) describes using a 1064 nanometer wavelength light source with an InP/InGaAsP photomultiplier. With regard to IR spectrometry, any of a variety of types of light sources can be used, including commercially available light sources.

Existing commercially available fiber optic probes may be used or may be modified, or new probes developed, to maximize collection efficiency of light from a SERS substrate, to efficiently interrogate particular types of deposits, such as deposits of particular shapes, to efficiently interrogate depositions on particular types of SERS substrates, etc. Such modified, or newly developed probes, may offer better signal-to-noise ratios and/or faster data collection. The probe may be modified or may be coupled to another device to help maintain a constant probe-to-sample distance, which may help to keep the system in focus and help maximize the collected signal.

The optical processor 140 may include one or more lenses for focusing the collected light. The optical processor 140 may also include one or more filters to attenuate laser light. Although shown separate from the spectrum analyzer 132, some or all of the optical processor 140 may optionally be a component of the spectrum analyzer 132.

The spectrum analyzer 132 may comprise a spectrograph optically coupled with a photo detector array. The photo detector array may comprise a charge coupled device, or some other photo detection device. For example, the article “Near-infrared multichannel Raman spectroscopy toward real-time in vivo cancer diagnosis,” by S. Kaminaka, et al. (Journal of Raman Spectroscopy, vol. 33, pp. 498-502, 2002) describes using a 1064 nanometer wavelength light source with an InP/InGaAsP photomultiplier.

In another embodiment, the spectrum analyzer 132 may comprise one or more filters to isolate a plurality of wavelengths of interest. Then, one or more photo detectors (e.g., a CCD, an avalanche photodiode, photomultiplier tube, etc.) could be optically coupled to the output of each filter. A single detector could be used with a tunable filter (e.g., an interferometer, liquid crystal tunable filter, acousto-optic tunable filter, etc.) or if fixed passband filters (e.g., dielectric filters, holographic filters, etc.) are placed in front of the detector one at a time using, for example, a slider, filter wheel, etc. In general, any of a variety of spectrum analyzers could be used such as a Raman analyzer, an IR spectrum analyzer, an interferometer, etc.

The computing device 144 may comprise, for example, an analog circuit, a digital circuit, a mixed analog and digital circuit, a processor with associated memory, a desktop computer, a laptop computer, a tablet PC, a personal digital assistant, a workstation, a server, a mainframe, etc. The computing device 144 may be communicatively coupled to the spectrum analyzer 132 via a wired connection (e.g., wires, a cable, a wired local area network (LAN), etc.) or a wireless connection (a BLUETOOTH™ link, a wireless LAN, an IR link, etc.). In some embodiments, the spectral content information generated by the spectrum analyzer 132 may be stored on a disk (e.g., a floppy disk, a compact disk (CD), etc.), and then transferred to the computing device 144 via the disk. Although the spectrum analyzer 132 and the computer 144 are illustrated in FIG. 1 as separate devices, in some embodiments the spectrum analyzer 132 and the computing device 144 may be part of a single device. For example, the computing device 144 (e.g., a circuit, a processor and memory, etc.) may be a component of the spectrum analyzer 132.

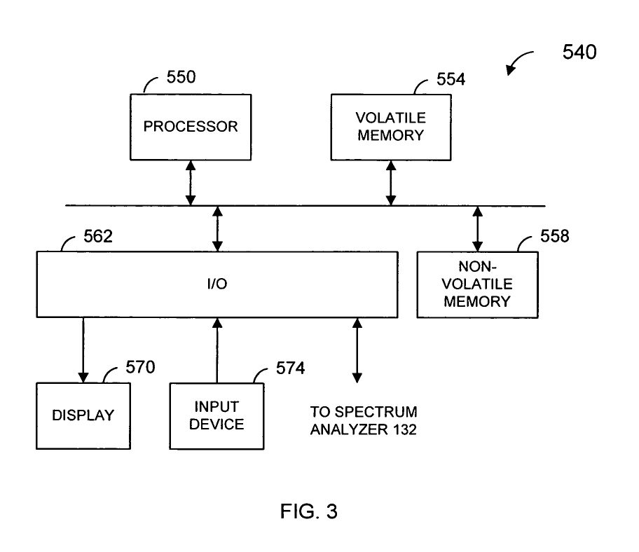

FIG. 3 is a block diagram of an example computing device 144 that may be employed. It is to be understood that the computer 540 illustrated in FIG. 10 is merely one example of a computing device 144 that may be employed. As described above, many other types of computing devices 144 may be used as well. The computer 540 may include at least one processor 550, a volatile memory 554, and a non-volatile memory 558. The volatile memory 554 may include, for example, a random access memory (RAM). The non-volatile memory 558 may include, for example, one or more of a hard disk, a read-only memory (ROM), a CD-ROM, an erasable programmable ROM (EPROM), an electrically erasable programmable ROM (EEPROM), a digital versatile disk (DVD), a flash memory, etc. The computer 540 may also include an I/O device 562. The processor 550, volatile memory 554, non-volatile memory 558, and the I/O device 562 may be interconnected via one or more address/data buses 566. The computer 540 may also include at least one display 570 and at least one user input device 574. The user input device 574 may include, for example, one or more of a keyboard, a keypad, a mouse, a touch screen, etc. In some embodiments, one or more of the volatile memory 554, non-volatile memory 558, and the I/O device 562 may be coupled to the processor 550 via one or more separate address/data buses (not shown) and/or separate interface devices (not shown), coupled directly to the processor 550, etc.

The display 570 and the user input device 574 are coupled with the I/O device 562. The computer 540 may be coupled to the spectrum analyzer 132 (FIG. 2) via the I/O device 562. Although the I/O device 562 is illustrated in FIG. 3 as one device, it may comprise several devices. Additionally, in some embodiments, one or more of the display 570, the user input device 574, and the spectrum analyzer 132 may be coupled directly to the address/data bus 566 or the processor 550. Additionally, as described previously, in some embodiments the spectrum analyzer 132 and the computer 540 may be incorporated into a single device.

A routine, for example, for measuring levels of biomarkers may be stored, for example, in whole or in part, in the non-volatile memory 558 and executed, in whole or in part, by the processor 550. For example, the block 70 of FIG. 1 could be implemented in whole or in part via a software program for execution by the processor 550. The program may be embodied in software stored on a tangible medium such as CD-ROM, a floppy disk, a hard drive, a DVD, or a memory associated with the processor 550, but persons of ordinary skill in the art will readily appreciate that the entire program or parts thereof could alternatively be executed by a device other than a processor, and/or embodied in firmware and/or dedicated hardware in a well known manner.

With regard to the method 50 of FIG. 1, one of ordinary skill in the art will recognize that the order of execution of the blocks may be changed, and/or the blocks may be changed, eliminated, or combined.

Although block 70 of FIG. 1 was described above as possibly being implemented by the computer 540, it could also be implemented, at least partially, by other types of devices such as an analog circuit, a digital circuit, a mixed analog and digital circuit, a processor with associated memory, etc.

At least portions of the techniques described above, including the blocks described with reference to FIG. 1, may be implemented using software comprising computer program instructions. Such computer program instructions may control the operation of a computing device such as an embedded processor, a desktop computer, a laptop computer, a tablet computer, a workstation, a server, a mainframe, etc. The computing device may have or be coupled to a memory in which the computer program instructions may be stored. The computer program instructions may be written in any high level language such as C, C++, C#, Visual Basic, Java or the like or any low-level assembly or machine language. By storing computer program instructions in a memory of the computing device, the computing device is physically and/or structurally configured in accordance with the computer program instructions.

While many methods and systems have been described herein as being implementable in software, they may be implemented in hardware, firmware, etc., and may be implemented by a variety of computing systems and devices. Thus, the method blocks and system blocks described herein may be implemented in a standard multi-purpose central processing unit (CPU), a special purpose CPU, or on specifically designed hardware or firmware such as an application-specific integrated circuit (ASIC) or other hard-wired device as desired. When implemented in software, the software routine may be stored in any computer readable memory such as on a magnetic disk, a laser disk (such as a compact disk (CD), a digital versatile disk (DVD)), a flash memory, a memory card, a memory stick, etc., or other storage medium, in a RAM or ROM of a computer or processor, in any database, etc. Likewise, this software may be delivered via any known or desired delivery method including, for example, on a computer readable memory or other transportable computer storage mechanism or over a communication channel such as a telephone line, the internet, etc. (which are viewed as being the same as or interchangeable with providing such software via a transportable storage medium).

Experiments

In a first experiment, rooster comb hyaluronic acid (HA, ˜2000 kDa), bovine serum albumin (BSA), γ-globulins, and human plasma (ca., 72% albumin and 15% γ-globulin) were obtained from Sigma-Aldrich and used as received. Canine synovial fluid and plasma were obtained using UCUCA-approved protocols. All other used reagents and solvents were of analytical grade.

Raman spectra were collected using a NIR-optimized Raman microprobe. It includes a 200 mW 785 nm laser (Kaiser Optical Systems, Inc.) and an epi-illumination microscope (Olympus, BH-2). Laser light was coupled with a 0.3 neutral density filter, Powell lens (Stocker-Vale), and lined-focused through a 20×0.75 NA Fluar objective (Carl Zeiss, Inc.). A laser power output of ˜45 mW was achieved at the objective. Raman scatter was collected using an f/1.8 axial transmissive spectrograph (Kaiser, HoloSpec) and detected using an air-cooled, back-thinned deep depletion CCD camera. Raman spectra were acquired with 20-60 second integration times. Wavenumber calibration and image curvature correction were performed in Matlab 6.1 (The Math Works, Natick, Mass.) using built-in and locally-written scripts.

HA standards (4-0.25 mg/mL) were prepared by serial dilution of an 8 mg/mL HA stock solution. Artificial synovial fluid standards (ASF) containing human plasma (A) were prepared by dissolution of 25 μL HA standards (4-0.25 mg/mL) in 25 μL solutions containing 11.5 μL deionized water and 13.5 μL human plasma, giving final HA, albumin, and globulin concentrations of approximately 4.0-0.25, 11.8, and 3.8 mg/mL, respectively. A human plasma solution (B) was prepared as an experimental control to the same concentrations of albumin and globulin. All solutions were stored at −4° C. until required.

50 μL aliquots of each solution (A-B) were transferred to 500 μL centrifuge tubes, followed by an equivalent volume of 10% trichloroacetic acid (TCA) solution. The centrifuge tubes were vortexed for 30 seconds, incubated at −4° C. overnight, and centrifuged at 9,500 rpm for 10 min. The clear supernatant layers were isolated and stored at −4° C. until required. The experiment was repeated using 10 μL canine synovial fluid (C) or canine plasma (D) with 10 μL TCA solution.

For all fluids examined, 0.3 μL of each solution (A-D) were deposited onto Klarite™ SERS Substrates (Mesophotonics Ltd, Hampshire, UK) and left to air dry at ambient temperature for 30 min. This drop deposition method of drying liquids onto the SERS substrate was used throughout the experiment. Raman spectra of the ring-like deposits were acquired using 20-60 sec integration times and ˜45 mW laser power. Normal Raman spectra of a 0.5 mg/mL HA deposits dried on bare gold and fused silica slides were also acquired. The resulting Raman spectra were offset to zero, corrected for contributions from the substrate, and baseline corrected in Grams/AI 7.01 software (ThermoGalactic). A seventh-order Savitsky-Golay smoothing factor was applied to each spectrum within the 780 and 1750 cm⁻¹ spectral range.

Experimental protocols such as signal integration, laser power and droplet volumes were optimized for simple and rapid collection of surface-enhanced Raman signal on Klarite™ SERS Slides. In artificial synovial fluid, strategies to reduce spectral interference from fluid proteins were explored.

The 899, 945, 1050, 1130 and 1410 cm⁻¹ bands were used to identify HA in synovial fluid preparations. Due to noise in the experimental system, band positions were reproducible to approximately ±2 cm⁻¹.

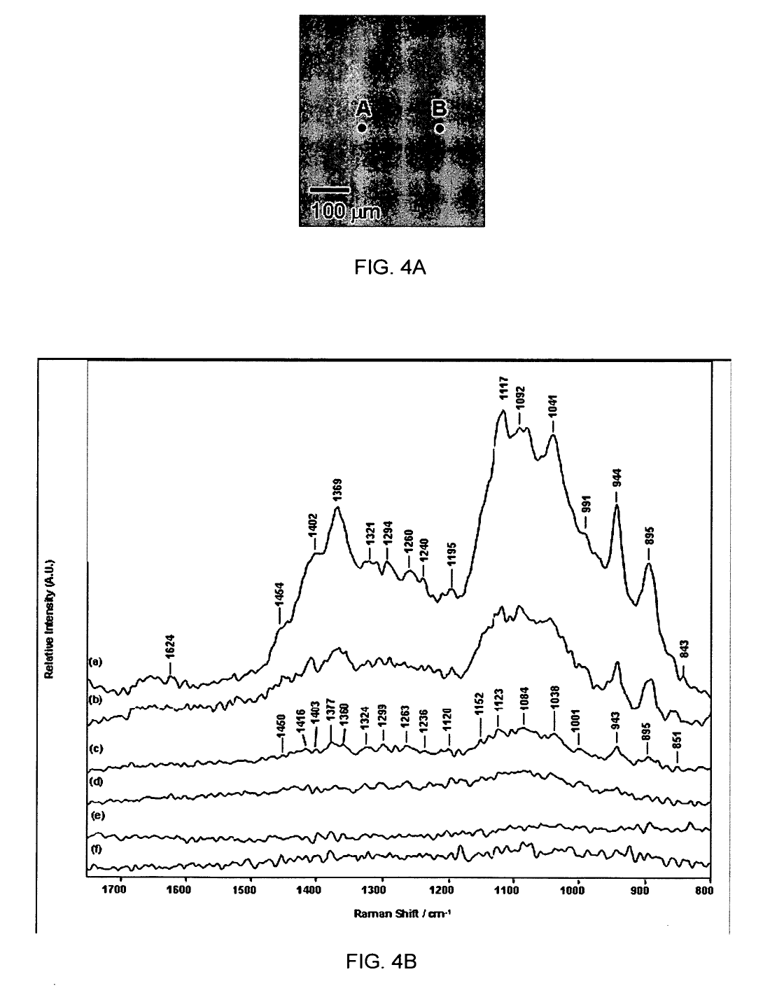

FIG. 4A is an image of a droplet of 0.5 milligram/milliliter aqueous HA solution dried on a SERS substrate, showing a point A on an outer ring and a point B on an inner ring along which Raman spectra were measured. FIG. 4B is a graph showing Raman spectra for (a) HA in solid form, (b) point A for 60 second integration, (c) point A for 20 second integration, (d) point B for 20 second integration, (e) a droplet of 0.5 milligram/milliliter aqueous HA solution dried on a bare gold substrate, and (f) a droplet of 0.5 milligram/milliliter aqueous HA solution dried on a fused silica substrate.

FIG. 4B seem indicates that normal (non-enhanced) Raman spectroscopy of HA levels is not possible at low concentrations (e.g., less than 2 milligrams/milliliter) of HA in solution. Raman bands from HA were observed when deposited onto the SERS substrate, with a laser intensity of ˜45 mW and signal integration for 20-60 seconds. The use of SERS substrates enabled rapid collection of HA spectra at low laser power. Moreover, the limit of detection was reduced by an order of magnitude, as compared to previous Raman HA reports.

The signal from HA deposited onto a SERS substrate was compared to signal on a fused silica surface. HA peaks were not detected after deposition onto a fused silica surface at low concentrations. Surface enhancement may be greater at concentrations below the entanglement threshold of HA, despite the poor Raman scattering of hyaluronic acid. Due to an increased scattering efficiency, a greater signal enhancement at lower concentrations (e.g., less than 2 milligrams/milliliter) was expected. At concentrations greater than 2 milligrams/milliliter, it is possible that cross chain entanglement increases and affects both the hygroscopic nature and mobility of the polysaccharide. Aggregation of HA may be more likely at these higher concentrations, and this “clumping” of HA may affect the collection efficiency.

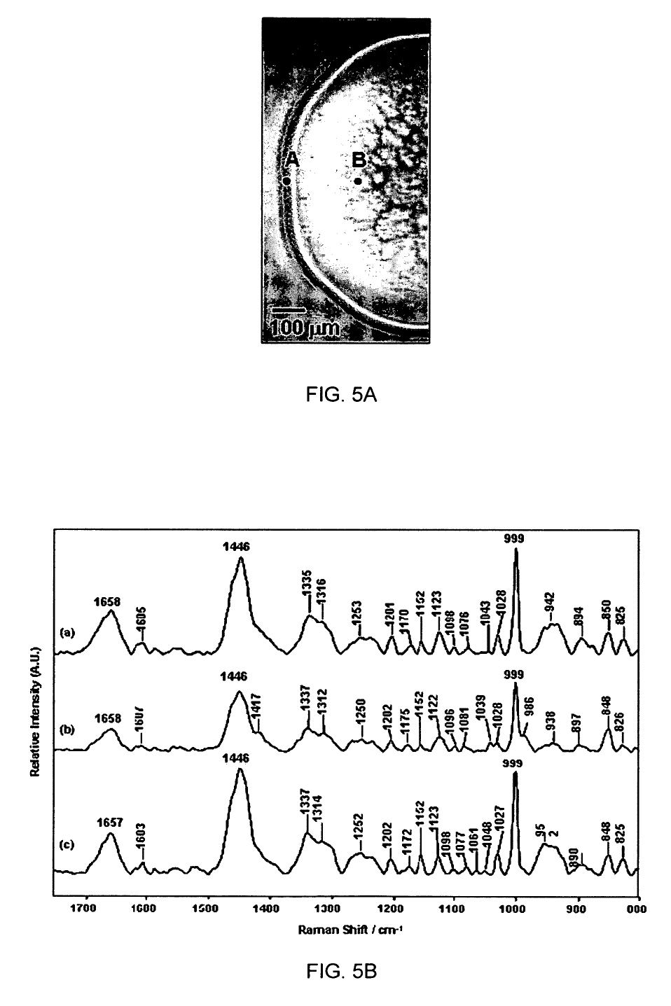

In simple models of synovial fluid, attempts to separate protein from HA indicated that the drop deposition method was insufficient for segregation, indicating significant protein interference. Raman spectra taken from droplets of artificial synovial fluid were dominated by protein bands, under a variety of drying conditions. FIG. 5A is an image of a droplet of canine synovial fluid dried on a SERS substrate, showing a point A in an outer ring and a point B closer to a center of the droplet along which Raman spectra were measured. Point B is 200 micrometers closer to the center of the droplet than point A. FIG. 5B is a graph comparing Raman spectra measured from the droplet of FIG. 5B with Raman spectra from canine plasma. For all the spectra in FIG. 5B, the fluids were not treated prior to analysis, and the Raman signal was integrated for 20 seconds at a laser power of 45 mW. FIG. 5B includes Raman spectra for (a) point A, (b) point B, and (c) a droplet of canine plasma.

As indicated by FIG. 5B, Raman spectra from protein bands dominated in bio fluids. Additional SERS studies of artificial synovial fluid also show that that HA binds non-specifically to proteins. Even at higher HA concentrations (2 mg/ml) in artificial synovial fluid, Raman spectra taken throughout the droplet were dominated by protein bands and no HA signal was observed. The white light images are another indication that simple chemical segregation of HA and protein mixtures may be inadequate for reduction of interferences from proteins. These white light images show the presence of a few concentric rings, but are probably due to segregation of free protein from protein/HA complexes rather than separation of HA from proteins. Solvent impurities, such as crystals from residual TCA, are still easily segregated from HA, and drop deposition was used in conjunction with more sophisticated methods of separating protein from HA in synovial fluid.

Several processes were evaluated for reducing spectral interference from proteins. Filtration, protein precipitation and ultracentrifugation methods to separate protein from HA were tested. Initial experiments showed that filtration of the synovial fluid did not reduce the protein signal. This may be due to hyaluronic acid non-specifically binding with synovial fluid proteins such as albumin or globulin. Protein precipitation, followed with ultracentrifugation, is a standard method for reducing the amount of protein in biological fluids.

The trichloroacetic acid (TCA) method of protein precipitation was utilized because it is simple, rapid and non-destructive. This method has been validated against commercially-available protein removal kits and found to provide adequate protein-removal efficiency. Although residual TCA solvent is observed throughout the dried droplet, the main bands are in the 600-800 cm⁻¹ region and did not interfere with HA signal.

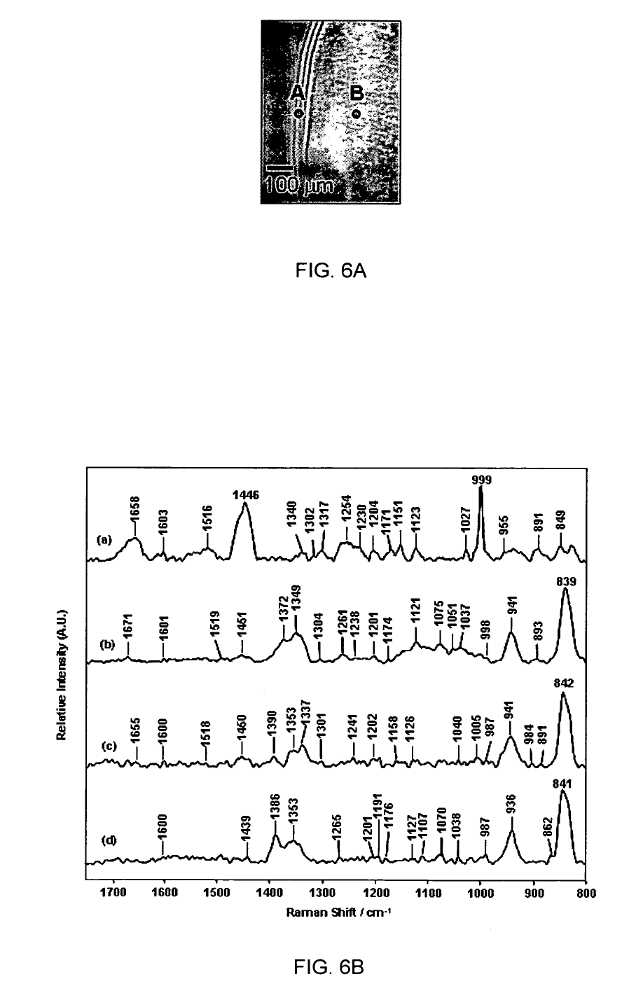

FIG. 6A is an image of a droplet of artificial synovial fluid spiked with 0.5 mg/mL HA and treated with 10% TCA solution. FIG. 6A indicates a point A in an outer ring and a point B closer to a center of the droplet along which Raman spectra were measured. FIG. 6B is a graph comparing Raman spectra measured from the droplet of FIG. 6A with Raman spectra from synovial fluid not treated with TCA. For all the spectra in FIG. 6B, the Raman signal was integrated for 20 seconds at a laser power of 45 mW. FIG. 6B includes Raman spectra for (a) untreated synovial fluid, (b) point A of treated synovial fluid, (c) point B of the treated synovial fluid; and (d) human plasma after TCA treatment.

FIG. 6B indicates that there is adequate reduction of the protein signal to enable identification of HA bands at elevated clinical levels. Both the albumin and globulin were effectively removed from the fluid, and several HA biomarker bands were easily observed. The ˜945 cm⁻¹ band may contain contributions from a TCA-HA complex, but bands in the 1030-1130 cm⁻¹ spectral region indicate the presence of HA.

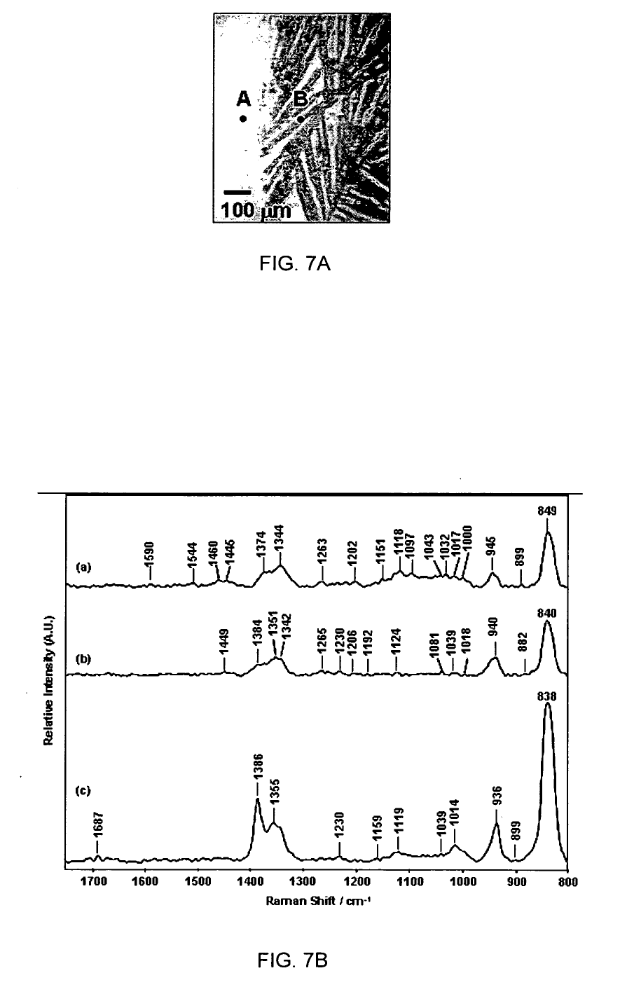

Canine synovial fluid on SERS was examined, and TCA pretreatment and ultracentrifugation were used to remove proteins. FIG. 7A is an image of a droplet of canine synovial fluid spiked with HA. FIG. 7A indicates a point A in an outer ring and a point B closer to a center of the droplet along which Raman spectra were measured. FIG. 7B is a graph comparing Raman spectra measured from the droplet of FIG. 7A with Raman spectra from canine synovial fluid treated with TCA but not spiked with HA. FIG. 7B includes Raman spectra for (a) point A, (b) point B, and (c) treated synovial fluid without HA. The ring that is closer to the droplet's center contains crystallized TCA and other impurities from proteins and, as expected, the spectrum at point B is predominately TCA with small amounts of protein visible. As a control, canine plasma was also treated with TCA and the resulting spectrum (c) is similar to the spectrum seen in (b). Since there is no HA in canine plasma, the spectral contributions from only the TCA and residual impurities were observed.

In a second experiment, Raman spectra were collected with a Raman microprobe, optimized for collection of near-infrared signal. The system included a 400 mW 785 nm laser (Invictus, Kaiser Optical Systems, Inc.) and an epiillumination microscope (Olympus, BH-2). Laser light was coupled with a 1.0 neutral density filter, Powell lens (StockerYale), and lined-focused through a 20×/0.75 NA Fluar objective (Carl Zeiss, Inc.). A laser power output of ˜8 mW was achieved at the objective. Raman scatter was collected using an f/1.8 axial transmissive spectrograph (Kaiser, HoloSpec) and detected using an air-cooled, back-thinned deep depletion CCD camera. Raman spectra were acquired with 60 or 120 second integration times. Wavenumber calibration and image curvature correction were performed in Matlab 6.1 (The Math Works, Natick, Mass.) using built-in and locally-written scripts. Light microscope images of droplets were collected using either a 5×/0.25 NA Fluar (Carl Zeiss, Inc.) or a 10×/0.50 Fluar (Carl Zeiss, Inc.) objective.

Rooster comb hyaluronic acid (HA, ˜2000 kDa), bovine serum albumin (BSA), γ-globulins, and human plasma (ca., 72 % albumin and 15 % γ-globulin) were obtained from Sigma-Aldrich and used as received. All other used reagents and solvents were of analytical grade.

Aqueous HA standards (4-0.25 mg/mL) were prepared by dilution of a 6-8 mg/mL HA stock solution in water. Artificial synovial fluid standards (ASF) containing human plasma were prepared by dissolution of 25 μL HA standards (4-0.25 mg/mL) in 25 μL solutions containing 11.5 μL deionized water and 13.5 μL human plasma, giving final HA, albumin, and globulin concentrations of approximately 2.0-0.125, 11.8, and 3.8 mg/mL, respectively. A human plasma solution (27% v/v in deionized water) was prepared as an experimental control at the same albumin and γ-globulin concentrations. All solutions were stored at −4° C.

50 μL aliquots of each solution (A-B) were transferred to 500 μL centrifuge tubes, followed by an equivalent volume of 10% trichloroacetic acid (TCA) solution. The centrifuge tubes were vortexed for 30 seconds, incubated at −4° C. overnight, and centrifuged at 9,500 rpm for 10 min. The clear supernatant layers were carefully extracted and stored at −4° C.

For all fluids examined, 0.2-0.3 μL of each solution were deposited onto Klarite™ SERS Substrates (Mesophotonics Ltd, Hampshire, UK) and left to air dry at ambient temperature for 30 min. Raman spectra of the ring-like deposits were acquired with 60 or 120 second integration times and ˜8 mW laser power. Normal Raman spectra of a 0.5 mg/mL HA deposits dried on bare gold and fused silica slides were also acquired. The resulting Raman spectra were examined between 800 and 1700 cm⁻¹. Pretreatment included subtraction of the detector offset, correction for contributions from the substrate, and baseline subtraction in Grams/AI 7.01 software (ThermoGalactic).

The 899, 945, 1050, 1130 and 1410 cm⁻¹ bands were used to identify HA in artificial synovial fluid (ASF) preparations. Noise in the measured Raman spectra limited the reproducibility of band positions to ±2 cm−1.

The effect of substrate surface and HA concentration on droplet shape was studied on fused silica, bare gold, and a SERS substrate. A consistent observation throughout these studies was the asymmetric ring shape when droplets dried on the SERS substrate. The droplet shapes were octagon-like. A similar droplet shape was observed when aqueous HA solutions at various concentrations (0.25-6 mg/ml) were deposited onto the SERS substrate. In addition to the non-spherical shape of the droplet, asymmetric concentric rings at the droplet edge were observed when highly concentrated aqueous HA solutions were deposited on the SERS substrate.

Previous studies have demonstrated that concentric ring formation is concentration dependent. Moreover, formation of concentric rings may be related to entanglement of the polymer chains because the concentric rings are not prominent at concentrations below 2 mg/ml. At concentrations greater than 2 mg/ml, it is possible that chain entanglement increases and affects both the hygroscopic nature and mobility of the polysaccharide. Aggregation of HA is more likely at these higher concentrations, and this “clumping” of HA may affect the droplet formation. The presence of these concentric rings does not prevent the collection of HA Raman spectra, and may provide additional information about the size distribution of the polysaccharide. Deposition of polygonal-type rather than circular rings appears to be a result of the interplay between evaporation and the geometry of the SERS substrate. Circular rings were observed when 0.2 μL drops of the same HA solutions were deposited on fused silica slides or the bare gold portions of SERS substrates.

The use of a SERS substrate enabled rapid collection of HA spectra. Even at higher concentrations, attempts to collect unenhanced Raman spectra were unsuccessful. No bands of HA deposited from a 6 mg/ml, 3 mg/ml or 0.5 mg/ml aqueous solution were found on fused silica or bare gold even at integration times of 120 seconds. Previously reported detection limits for HA solutions by normal Raman spectroscopy are in the 40-50 mg/ml range. The limit of detection was reduced by at least two orders of magnitude (approximately 0.5 mg/mL) using the experimental technique. This limit may be lowered by using additional techniques such as multivariate analysis, optimized probes, optimized illumination, optimized collection, evaporation schemes that result in smaller ring diameters, etc. For instance, as HA concentration is reduced the ring of precipitated HA becomes narrower. Because in the experiment, the droplet edge was illuminated by a line-focused laser, most of the deposited HA was not interrogated.

The experimental method of producing a droplet allowed identification of HA in aqueous solutions at concentrations ranging from 6 mg/ml to 0.25 mg/ml on the SERS substrate. After pre-processing, bands at ˜895 cm⁻¹, 945 cm⁻¹, and 1042 cm⁻¹ were fit using a routine in Grams/AI 7.01 software. The effect of HA concentration on band area, band width and band height were examined. The width of the 895 cm⁻¹ band increased with HA concentration. The heights of the 895, 945 and 1042 cm⁻¹ bands remained almost constant in the 0.25-3 mg/ml range. This may indicate that monolayer coverage had been reached or perhaps exceeded. The band width is closely related to polymer conformation, which may provide additional information on HA conformation distribution within the ring. The width of the 895 cm⁻¹ band, related to the β-linkages that connect alternating N-acetyl-glucosamine and Dglucuronic acid units, increased approximately linearly with concentration in the 0.25-3 mg/ml range. Raman band width may be a more robust indicator of HA concentration because it may be relatively independent of small variations in the substrate surface and can be used at analyte concentrations that yield monolayer or multilayer deposits.

Drop deposition alone appeared to be inadequate for separation of HA from the proteins present in synovial fluid. SERS spectra taken from deposits of artificial synovial fluid showed protein bands that completely obscured the nearby HA bands. The same problem was encountered with canine synovial fluid and canine plasma. Further study of the SERS of artificial synovial fluid showed that that HA probably binds non-specifically to proteins. Even at higher starting HA concentrations (e.g., 2 mg/ml) in artificial synovial fluid, Raman spectra taken anywhere in the deposit were dominated by protein bands that obscured any HA signal.

Light microscope images of the deposits from untreated artificial synovial fluid confirmed that simple chemical segregation of HA and protein mixtures was inadequate for reduction of interferences from proteins. A few concentric rings were observed, but only protein spectra were seen in all of them. Small molecule impurities were still easily segregated from HA.

Trichloroacetic acid (TCA) protein precipitation followed by ultracentrifugation was successful in removing proteins from HA, was rapid and did not interfere with the identification of key Raman biomarker bands associated with HA.

It should be noted that the TCA protocol dilutes HA in ASF by a factor of two. Although microscope images and Raman spectroscopy show crystalline TCA in the center of the dried droplet deposit, Raman spectra show that some TCA is still contained in the outer HA-rich rings. A broad TCA band was observed between 830-860 cm⁻¹ and other bands were found at ˜945 cm⁻¹ and 1365 cm⁻¹. With the exception of the 945 cm⁻¹ band, TCA bands did not appear to overlap with HA Raman bands and were not significant sources of interference.

Both albumin and γ-globulin were almost completely removed from the biofluids by precipitation with 10% TCA. HA bands were observed at 899, 1040, and 1117 cm⁻¹ after treatment with TCA. By contrast, the intense phenylalanine ring breathing band at ˜1000 cm⁻¹ was reduced to intensities similar to or lower than the intensities of the most intense and characteristic HA bands.

The present disclosure has been described with reference to specific examples, which are intended to be illustrative only and not to be limiting. It will be apparent to those of ordinary skill in the art that changes, additions or deletions may be made to the disclosed examples without departing from the spirit and scope of the disclosure.

1. A method for measuring cartilage condition biological markers, the method comprising:
irradiating a surface-enhanced Raman spectroscopy (SERS) substrate using a light source, the SERS substrate having deposited thereon a biological sample;
receiving light scattered by the SERS substrate;
determining spectral content information associated with the received light; and
determining a level of a cartilage condition biological marker in the biological sample based on the spectral content information.

2. A method according to claim 1, further comprising determining a cartilage condition based at least in part on the level of the cartilage condition biological marker.

3. A method according to claim 1, further comprising obtaining the biological sample.

4. A method according to claim 3, further comprising processing the biological sample to separate, at least partially, the cartilage condition biological marker from proteins in the biological sample.

5. A method according to claim 1, wherein the SERS substrate comprises a silicon substrate having a metallic layer deposited upon a surface of the silicon substrate.

6. A method according to claim 5, wherein metallic layer comprises at least one of gold, silver, or copper.

7. A method according to claim 1, wherein the cartilage condition biological marker is indicative of whether a patient has an arthritis condition.

8. A method according to claim 1, wherein the cartilage condition biological marker comprises one or more glycosaminoglycans.

9. A method according to claim 8, wherein the cartilage condition biological marker comprises hyaluronic acid.

10. A method according to claim 1, wherein determining the level of the cartilage condition biological marker comprises determining at least one of a height or an area of at least one spectral band.

11. A method according to claim 1, wherein determining the level of the cartilage condition biological marker comprises determining a width of at least one spectral band.

12. A method according to claim 1, wherein irradiating the SERS substrate comprises irradiating the SERS substrate to form an illumination pattern having a shape of at least one of a circle or a ring.

13. An apparatus for measuring cartilage condition biological markers, comprising:
an illumination system to illuminate a surface-enhanced Raman spectroscopy (SERS) substrate, the SERS substrate having deposited thereon a biological sample;
a light receiver to receive light from scattered by the SERS substrate;
a spectrum analyzer optically coupled to the light receiver, the spectrum analyzer configured to generate spectral content information associated with the received light; and
a computing device communicatively coupled to the spectrum analyzer, the computing device configured to determine a level of a cartilage condition biological marker in the biological sample based on the spectral content information.

14. An apparatus according to claim 13, wherein the computing device is further configured to determine an indicator of a cartilage condition based at least in part on the level of the cartilage condition biological marker.

15. An apparatus according to claim 13, wherein the SERS substrate comprises a silicon substrate having a metallic layer deposited upon a surface of the silicon substrate.

16. An apparatus according to claim 15, wherein metallic layer comprises at least one of gold, silver, or copper.

17. An apparatus according to claim 13, wherein the computing device is configured to determine a level of a cartilage condition biological marker that is indicative of whether a patient has an arthritis condition.

18. An apparatus according to claim 13, wherein the computing device is configured to determine a level of one or more glycosaminoglycans.

19. An apparatus according to claim 18, wherein the computing device is configured to determine a level of hyaluronic acid.

20. An apparatus according to claim 13, wherein the computing device is configured to determine at least one of a height or an area of at least one spectral band.

21. An apparatus according to claim 13, wherein the computing device is configured to determine a width of at least one spectral band.

22. An apparatus according to claim 13, wherein the illumination system is configured to irradiate the SERS substrate to form an illumination pattern having a shape of at least one of a circle or a ring.
